(19) United States
(12) Patent Application Publication
(10) Pub. No.: US 2006/0074742 A1
(43) Pub. Date: Apr. 6, 2006

(54) Scent delivery devices and methods

(76) Inventor: Carmine Santandrea, Santa Barbara, CA (US)

Correspondence Address: Keith Scala;Myers Bradford, PLLC, 1731 Willard St., No. 502, Washington, DC, 20009, US

(21) Appl. No.: 11/234,202

(22) Filed: Sep. 26, 2005

Related U.S. Application Data
(60) Provisional application No. 60/612,795, filed on Sep. 27, 2004.

(51) Int. Cl. G07G 1/00

(52) U.S. Cl. 705/10; 422/124; 705/14

(57) ABSTRACT

A method is described for enhancing multimedia advertising, sales or product promotion, public relations, entertainment or instructional systems by incorporating scent. The method includes steps of selecting a product or service, and delivering a multimedia advertising, sales promotion, public relations, entertainment, brand awareness or educational campaign which appeals to the sense of smell and one or more of the other senses. Methods are provided for measuring improvements in the effectiveness of multimedia advertising, sales or product promotion, public relations, entertainment or instructional systems occur when scent is incorporated into the campaign.

This application claims the benefit of the filing date of provisional application 60/612,795, filed on Sep. 27, 2004.

### FIELD OF THE INVENTION

This invention relates generally to methods to enhance sales through multi-sensory based advertising, promotion, public relations, entertainment or instructional methods. More particularly, the invention relates to advertising, promotion, public relations, entertainment or instructional methods which employ scent in combination with other media. Further, the invention relates to applications of scent in the consumer environment.

### BACKGROUND OF THE INVENTION

Advertising, sales promotional campaigns, product related public relations and product related instruction methods traditionally use film, television, radio, the Internet and print media as methods to persuade customers to purchase specific products. Television, movies, radio, the Internet and print advertising and promotional efforts are currently so ubiquitous that their effectiveness has been compromised even as the price of traditional advertising and promotion is rising [“Mass Media: Killing The Goose That Lays Golden Eggs”. BusinessWeek Online (Readers Report). Aug. 2, 2004]. In addition, film, TV, radio, Internet and print advertising primarily conventionally appeal to only two senses: sight and sound. As a result of rising advertising and sales promotion costs and declining effectiveness, there is a pressing need for new approaches to advertising, sales promotion, product public relations, story telling and instructional methods and there is a pressing need for methods to determine the effectiveness of advertising campaigns and communications.

The problem of effective communication advertising and promotional methods is particularly pressing in the commercial, retail environment where consumers are presented with a bewildering array of product choices and where advertisers have severely limited opportunities to convey a message. The Internet, one of the newest commercial environments, suffers from the same problems as the more traditional commercial arenas. On the Internet, customers are known to have a short attention span and limited patience, thereby limiting the ability of traditional advertising to convey product information and influence buying decisions.

One solution to the dilemma is to provide a multisensory, multimedia experience which enhances traditional visual and aural cues with at least olfactory cues. Scent, which acts on the limbic system of the consumer, evokes powerful emotional and memory experiences that can aid in persuading a consumer to purchase a product.

The power of scent to enhance or alter an experience is recognized in the art. U.S. Pat. No. 6,103,201, US20020130146A1 and U.S. Pat. No. 6,664,254 describe the use of scents in air fresheners to help cover offensive household odors. EP0495631A3, U.S. Pat. No. 5,220,741, U.S. Pat. No. 4,788,787 and WO0126818A1 describe the use of scents and pheromones as lures to attract animals to hunters or to repel insects. U.S. Pat. No. 5,963,302, U.S. Pat. No. 6,239,857, U.S. Pat. No. 6,152,829, US2001/0048641A1, US2004/0065748, U.S. Pat. No. 4,629,604 and U.S. Pat. No. 5,398,070 describe the application of scent to enhance movie, cinema, TV, video cassette and DVD viewing experiences, but these authors do not describe the use of entertainment media and scent for product-related instruction or public relations in the above applications.

The power of scent to alter mood or behavior for a person is also well recognized. EP0295129B1, WO9801175A1 and US2002/0124409A1 describe the medical and mood-altering characteristics of scent. U.S. Pat. No. 5,826,357 describes an artificial fireplace where fire scent sets the mood and enhances the experience. U.S. Pat. No. 6,669,092 describes a multimedia system to provide a virtual environment in order to reduce stress in a hospital or clinic. An advantageous application of scent delivery technology would be a personal scent delivery system which is capable of enhancing mood or behavior and reducing the stress level of a person within their home, office or similar enclosed space.

Multimedia advertising employing scent is known in the art. JP06328880A2, US20020158076A1, U.S. Pat. No. 6,557,778, U.S. Pat. No. 5,503,332 and U.S. Pat. No. 5,967,55 describe the use of scent to advertise and promote products in magazines and other print media, including transit tickets. US20030164268A1, US20030167284A1, US20030167464A1 and US20030177097A1 describe multimedia advertising applications for elevators where content is tailored to the expected interests of the elevator occupant. US20030129757A1 describes a food packaging system which allows a consumer to experience the scent characteristics of a finished product despite a sealed package. US20020047020A1 describes a vending system which allows a consumer to sample the sensory characteristics of a product before purchasing it. Similarly, ScentAir™ has reported dramatic increases in chocolate sales from vending machines when airborne chocolate scent is delivered into the region around the vending machine [Vending Times. 43(11) November, 2003].

One common example of a scent delivery device is an air freshener device in which a wick delivers a scent to an evaporative surface. WO03061716A1, U.S. Pat. No. 4,419,326, WO0230220A1, U.S. Pat. No. 5,857,620, U.S. Pat. No. 5,749,520, WO04014440A1 represent examples of the art. WO0230220A1 describes wick with specific pore characteristics for more effective scent delivery. U.S. Pat. No. 6,102,201 describes a scent bearing fan where scent is contained in the bearing of the fan. However, none of these devices describes a system in which the scent delivery system is incorporated into other mechanical components of the scent delivery system such as the fan itself. U.S. Pat. No. Unique in-store multimedia scent delivery devices have also been described. U.S. Pat. No. 6,026,987 describes a mannequin which delivers scent and audio messages. U.S. Pat. No. 5,771,778 describes a jukebox which delivers music and scent. U.S. Pat. No. 3,844,057 describes lighted in-store display boxes which also incorporate scent. U.S. Pat. No. 5,069,876 describes a point-of-sale device incorporating audio, visual and scent cues. US20040103028A1 and US20030066073A1 describe in-store multimedia displays that sense the presence of a potential customer and change their displays in response to an approaching potential customer. US20040044564 describes a method in which in-store displays can be updated based on historical trends and current customer behavior using information supplied by a set of sensors located in the commercial environment.

Most known multimedia sensory experiences result from the delivery of a single scent. However, it is also widely understood consumers become insensitive to a scent after a short exposure. As a result, it would be advantageous to provide multimedia advertising, sales promotion, public relations, entertainment or instructional systems in which multiple scents are delivered in a scenting program where a scenting program comprises combinations of scents, scent delivery concentrations, scent delivery durations and scent delivery pauses. EP295120B1 describes a scent program for aroma therapy. U.S. Pat. No. 4,603,030 describes a scent program for a theater. US20040007787 describes a program for room scents.

It is widely believed that a cue mismatch where an inappropriate scent is delivered in a multimedia presentation results in consumer dissatisfaction. As a result, it is desirable to provide methods to assure that the elements of a multi-sensory, multimedia campaign be linked, preventing incorrect associations from developing in a consumer's mind. U.S. Pat. No. 6,669,092 describes a method to coordinate elements of a virtual environment employing a light box, audio player and a scent distributor by electronically tagging each element.

Rising advertising costs and decreasing advertising effectiveness argue for choosing to use only cost-effective advertising. However, none of the examples provide means to objectively measure the success or failure of the advertising, sales promotion or public relations or instructional campaign which employs scent. As a result, it would be advantageous to provide multimedia advertising, sales promotion, public relations, entertainment or instructional programs which measure the effectiveness of the program.

### OBJECT OF THE INVENTION

It is therefore an object of the present invention to provide a method for enhancing the sale of a product by providing multimedia stimulus methods employing one or more scents in conjunction with media that evoke responses from one or more of the other senses.

Another object of the invention is to provide a measurement of the effectiveness of an advertising, sales promotion, public relations, entertainment or instructional method.

Another object of the invention is to provide brand enhancement by combining scent with multimedia experience.

Still another object of the invention is to provide an enhanced Internet shopping experience by combining scent with Internet based advertising, sales promotion, public relations, entertainment or instructional methods.

Still another object of the invention is to provide a method to coordinate multimedia advertising, sales promotion, public relations, entertainment or instructional materials.

Yet another object of the invention is to provide a distinctive personal environment by local delivery of scent in a scent program.

### SUMMARY OF THE INVENTION

The present invention provides a system for multi-sensory, multimedia advertising, sales promotion, education or product public relations campaign and a method to rapidly assess the effectiveness of an advertising campaign. The method provides both scent cues and more traditional non-scent based cues to help influence a customer toward the purchase of a selected, target product.

The present invention contains several elements that in combination provide a uniquely accountable advertising method. In general, the method comprises a product which is displayed and offered for sale in a commercial environment or zone, one or more scents corresponding to the product which are delivered into a scenting zone according to a scent program, non-scent advertising or sales promotional materials, educational materials or product public relations materials and strategically located counters which measure the effectiveness of the advertising or sales promotion campaign.

The present invention may be applied to traditional retail commercial environments such as grocery stores, gas stations, pharmacies, department stores and the like. Alternatively, the method may be equally effectively applied to sales of products on the Internet where a potential customer is physically separated from a direct product experience.

The present invention may be used to advertise or promote any product, but the method is especially well suited to products where the normal scent is masked by packaging. Examples of food products to which the method is well suited include coffee, rolls, chocolate bars, frozen foods and the like. Other examples of suitable products include laundry products, new or used cars, lawn products such as fertilizers, cosmetics and the like. It will be understood by those skilled in the art that many other examples are also possible.

The present invention may also be applied to brand building activities in which a customer is exposed to a product in an environment containing one or more scents corresponding to the brand and other non-scent based advertising, sales promotion, educational or product public relations material. A result of a brand building activity is to induce a potential customer to associate a specific product brand with a scent or scent program.

The present invention may also be applied to development of a personal brand or personal aura in which a unique scent combination is delivered into a scenting region, inducing a response. The responses induced include relaxation, the presence of specific person in the room and other possible responses.

### BRIEF DESCRIPTION OF THE DRAWINGS

FIG. 1 is a flow-chart showing an advertising or promotional method with an effectiveness measurement method comprising a product in a commercial zone, advertising or other promotional materials located in the commercial zone, a detector in the commercial zone which identifies a potential customer entering the zone, a detector at the point of purchase which counts sales of the product, a time measurement device, and a comparator through which the efficiency of an advertising program can be measured.

FIG. 2 is a flow-chart showing a multimedia advertising or promotional method with an effectiveness measurement method comprising a product in a commercial zone, a detector in the scenting zone which identifies a potential customer entering the scenting zone, a scent delivery system which delivers one or more scents in a scenting program related to the non-scent advertising materials located in the commercial zone, a detector at the point of purchase which counts sales the product, a time measurement device, and a comparator through which the efficiency of an advertising program can be measured.

FIG. 3 is a flow chart showing a multimedia advertising or promotional method with an effectiveness measurement method comprising an advertising zone which contains non-scent related advertising or promotional materials for a product, a scenting zone into which one or more scents related to a product are delivered according to a scenting program, a product zone, which is optionally remote from the scenting and advertising zones, a first counter operationally connected to a scent dispersal system and a customer detector, an automatic door opener which is operationally connected to the scent dispersal system and a customer detector, a detector at the point of purchase which counts sales of the product and a comparator through which determines the efficiency of an advertising program can be measured.

FIG. 4 is an exploded view of a strip-like scent delivery device. The scent delivery element is configured as a strip, sheet or similar shape with substantial surface area. The strip-like scent delivery device package comprises a polymeric material configured with an extended surface area, a scent or scents which are characteristic of a selected product or brand which are compatible with the polymeric material and which can be incorporated into the polymeric material. The polymeric material is chosen to release scent at a controlled rate. A removable covering device or layer which is impermeable to scent sandwiches the scent delivery element and permits scent delivery only upon removal or breakage. Optionally, one or more exterior surface of the device can be coated with a suitable adhesive, allowing the completed device to stick to a package or product surface. When a shipping package is readied for display, the barrier seal is broken and scent is released. The scent material is attached not so much to the individual packages but the shipping case or display or to a price strip located near the product display.

FIG. 5 is an elevation view of a scent delivery device which fits into a standard light fixture. The device can be turned on or off using a standard light switch. The fan blade of the scent delivery device is preloaded with a scent or scents. Or a scent cartridge can be in the proximity of the fan blade where the movement of the fan blade draws the scent from the cartridge. This can also be in the form of a scented grill in front of the fan. When the light switch is turned on, the motor is energized and the fan blades turn. Air flow over the fan blades delivers the selected scent into a selected area. Optionally, the motor can generate heat facilitating vaporization of scent. Also optionally, a separate heater to facilitate vaporization of scent can be incorporated into the device. This could be a light or projection lamp incorprorated in the device.

### DETAILED DESCRIPTION OF THE INVENTION

### DEFINITIONS

The following terms have meaning described below and are used throughout this specification:

Advertising Zone. An advertising zone is an area containing advertising materials, product promotional materials, product educational materials, brand awareness activities or materials, or public relations materials for a product, company or group of people. Advertising is intended to be construed in its broadest terms to include materials and processes related to advertising, product promotion, product education, and product public relations materials. Non-limiting examples of advertising materials include signs, leaflets, gobos, light boxes, holographic displays, audio tapes or recordings, computer displays and the like.

“Non-scent” used in the context of multi-media advertising means a combination of advertising materials which stimulate primarily one or more of the senses of taste, touch, hearing or sight, but which are not primarily directed toward the sense of smell.

Commercial Zone. A commercial zone is an area in which a product is displayed or presented, and offered for sale. Typically, a commercial zone will be found in a retail store or other establishment. Non-limiting examples of establishments which contain commercial zones include a gas station, a bakery, a grocery store, a drug store, a cosmetics retailer. Vending machine locations contain commercial zones. In cases where a product is offered for sale, a commercial zone can also include areas in a theater, a concert, a movie house, a cinema, or a lecture hall. Commercial zones may be confined to a phone or fax as well. Similarly, a commercial zone can include a home when a product is offered for sale using any suitable media.

Sales Environment. A sales environment is any location in which sale of a product occurs. Typically a sales environment contains a commercial zone where a product is displayed and offered for sale, but a sales environment also contains other facilities such as entry ways, customer service areas, product check-out areas and the like. A sales environment may contain a scenting zone or an advertising zone.

Scent. Scent is broadly defined to include aromas, fragrances, perfumes and pheromones. Scent can also be a molecule that removes mal odor molecules of smell. A scent is typically a volatile or at least nominally vaporizable material that stimulates receptors located primarily in the nose. Scents may be powerful stimulants. A scent may affect the limbic system and evoke significant physiological responses, emotional reactions and memories that can aid advertisers in delivering an advertising message if the scent is properly chosen and properly delivered. A substantial variety of scents are available from commercial vendors such as Lebermuth (South Bend, Ind.), Aroma Tech (Somerville, N.J.), Orpheus, Ltd. (Rockway, N.J.) or ScentAir (Santa Barbara, Calif.). These products are typically used in candles, aroma therapy, advertising, and air-modifications such as air fresheners and the like.

Pheromones. A pheromone is a chemical secreted externally by animals or insects that influences the physiology or behavior of other animals of the same species. Human pheromones may significantly affect human behavior if properly presented, and represent an essentially untapped field for advertisers.

Scenting Zone. A scenting zone is an area into which one or more scents are delivered. The size of a scenting zone can be adjusted depending on the product being advertised and the establishment in which the advertising is occurring.

Scenting Program. A scent program comprises a combination of scents, scent delivery concentrations, scent delivery durations and scent delivery pauses. A scent program can be considered analogous to a musical score where scent notes are similar to music notes. The scent delivery duration may be similar to playing whole, half or quarter notes, etc., and scent delivery pauses may be equivalent to musical rests.

Scent Delivery Device. Delivery devices for scents have one or more key elements: a volatile scent or scent solution; a heating device; a fan or other scent transport device, and appropriate ducts, dampers or tubes or other mechanical means to deliver the scent to a desired location. Examples of scent delivery devices include Green, D. in U.S. Pat. No. 6,103,201, which describes a fan with various shapes, Manne, J. in US20020018181A1 describes a system of tubes and a mask for delivering scent directly to a person's nose. Wohrle, G. in US20030107139A1 a plurality of cartridges containing scented fluids, scents in pockets in a tray and a heating systems to evaporate or vaporize a scent or scents. Shaahin, S. in WO03068300A1 describes a scent delivery system containing temperature control to avoid formation and inhalation of harmful degradation products. Prueter; D. in U.S. Pat. No. 6,631,888 describes a battery operated fragrance delivery device containing a fan where the cap contains ductwork and an on-off switch. Stenico, F. in WO03086487A1 which describes a delivery system with a wick, an evaporator, a fan and a system of louvers. In the present invention, any suitable combination of scent delivery elements may be employed.

Time-slice. A time-slice is a time period during which the efficiency of an advertising campaign is assessed. A time-slice duration is chosen for convenience of the measurement. Typically, a time-slice can be measured in seconds, minutes, hours, days, weeks, months or years.

Advertising Method with an Effectivness Measurment

With advertising costs rising and advertising effectiveness diminishing, a method for advertising which provides a measurement of the effectiveness of an advertising campaign is needed. The effectiveness measurement provides managers with objective tools to decide whether to continue an advertising or promotional campaign or communications message.

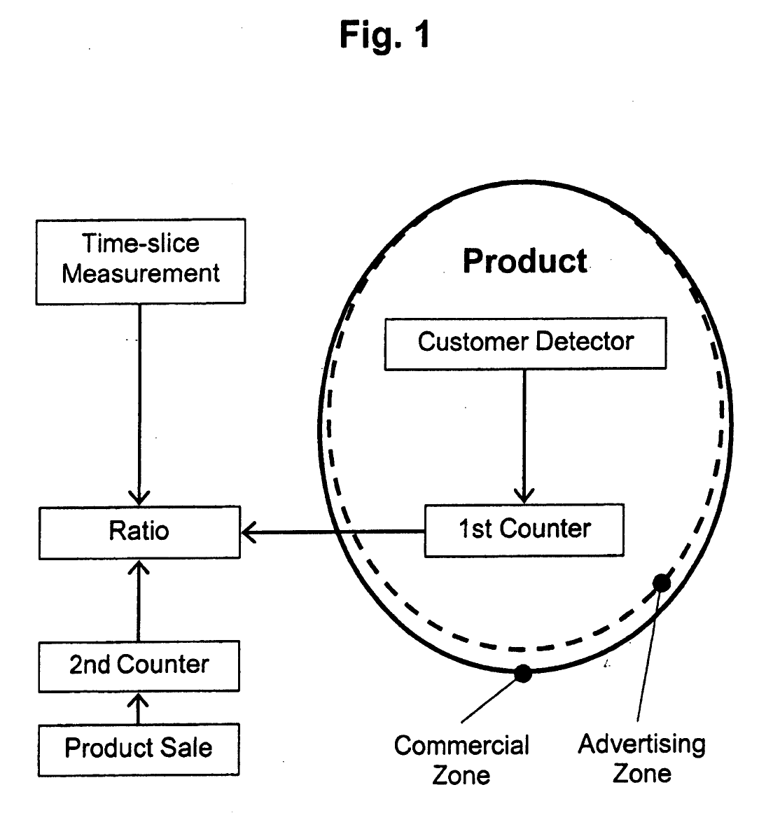

FIG. 1 shows an advertising method with a measurement of effectiveness. The method comprises selecting a product for the campaign and a duration or time-slice for the campaign. The product is displayed for sale in a commercial zone within a sales environment. A region containing the product, and an advertising zone within the commercial zone, contain a detector to determine when a potential consumer enters the advertising zone, thereby triggering an increment of the first counter. A second counter is connected to or acquired from equipment at the point-of-purchase and is triggered when the selected product is purchased. The first and second counters are connected to a comparator from which a measurement of effectiveness is derived. A comparator can be incorporated into one of the counters.

A time-slice is chosen for convenience of the measurement and is selected to be long enough to accurately assess the effectiveness of the advertising or sales promotion campaign. The duration of a time-slice is preferably measured in seconds, minutes or years. More preferably, a time-slice is measured in hours, days, weeks or months.

In order to measure the effectiveness of an advertising or sales promotion campaign, it is necessary to create an objective measurement of consumer interest in the product. One measurement is to define a scenting, advertising or commercial zone around a product and determine how frequently a consumer touches, views, considers or is physically near a product for sale vs. how often the same product is sold. While it is possible to station a person with a counter near a product display, the solution is typically cost prohibitive and prone to human errors. A more cost-effective and more accurate solution is to provide a sensor which determines when a potential customer enters the commercial zone.

A variety of sensors are capable of sensing the presence of a potential customer in a commercial, advertising or scenting zone. The general classes of sensors that are capable of detecting a potential customer in a commercial zone include heat or infrared sensors, microwave sensors, capacitance sensors, electromagnetic field sensors, motion sensors, light sensors, retinal or iris scan sensors, biometric sensors, pressure sensors, audio or ultrasonic sensors, and digital images.

The method of measuring the effectiveness of an advertising campaign are related to the scientific method in which results for a control group are compared to the results for an experimental group. To initiate an effectiveness measurement, a control, baseline or first sales rate is measured before a new advertising, sales promotion, educational or public relations campaign is initiated. Then, the campaign is initiated and a second sales rate is determined. The sales increment between the second and first sales rate is a quantitative measurement of the effect of the campaign.

FIG. 1 illustrates an advertising, sales promotion, educational or public relations campaign effectiveness measurement process. A selected product is displayed for sale in an advertising zone within a commercial zone of a sales environment. To measure the effectiveness of a campaign, a first sales rate is measured, as exemplified in the following steps:
1. Both the first and second counters are set to zero at the beginning of a first measurement period, a time-slice (TS1).
2. When a potential customer enters the advertising zone, the customer detector identifies appropriate behavior. Appropriate behavior is predefined and includes, but is not limited to, changes in eye, hand or body movements, changes in heart rate, changes in the electrical or electromagnetic spectrum of the potential customer or changes in the physical position of a potential customer.
3. A first counter is triggered and the counter counts all potential customers according to appropriate preset criteria with in the time-slice, forming a value FCV1.
4. A second counter is located at a check-out or other location where a product is purchased. The second counter is triggered when the selected product is purchased and counts accumulate during the time-slice forming a value, SCV1.
5. If time-slice for the first sale rate, baseline measurement and the second sale rate measurements are constant, the first sales rate, FSR, can be calculated as follows:
   FSR1=SCV1/FCV1 Eq. 1
6. If the time-slices for the first sales rate measurement and second sales rate measurement are not equal, the first sale rate measurement can be calculated as
   FSR2=SCV1/FCV1/TS1 Eq. 2
7. When baseline measurements are completed, the advertising campaign is installed in the advertising zone. As the campaign is initiated both counters are set to zero in order to initiate the second sales rate measurement, initiating a second time-slice measurement, TS2.
8. When a potential customer enters the advertising zone containing the advertising campaign, the customer detector identifies appropriate behavior. Appropriate behavior is predefined but is the same behavior measured in Step 2.
9. A first counter is triggered and the counter counts all potential customers according to appropriate preset criteria with in the time-slice, forming a value FCV2.
10. A second counter is located at a check-out or other location where a product is purchased. The second counter is triggered when the selected product is purchased and counts accumulate during the time-slice forming a value, SCV2.
11. If time-slice for the first sale rate, baseline measurement and the second sale rate measurements are constant, the second sales rate, SSR, can be calculated as follows:
   SSR1=SCV2/FCV2 Eq. 3
12. If the time-slices for the first sales rate measurement and second sales rate (ssr) measurement are not equal, the second sale rate measurement can be calculated as follows:
   SSR2=SCV2/FCV2/TS2 Eq. 4
13. The increment in sales (ISR) due to the advertising method employed can be estimated by comparing the first sales rate with the second sales rate. If the time-slices, TS1 and TS2, are the same, the following equation defines the sales increment.
   ISR1=SSR1−FSR1 Eq. 5.
14. If the time-slices, TS1 and TS2, are unequal, the following equation defines the sales increment.
   ISR2=SSR2−FSR2 Eq. 6.
   ISR2 multiplied by a time-duration is an estimate of the sales increment due to adding scent to the multimedia advertising campaign, and can be directly monetized for a merchant or other advertising customer.

Several variations of the above themes are possible. Steps 1-6 and Steps 7-14 can be applied sequentially in a single sales environment. Optionally, Steps 1-6 and Steps 7-14 can be conducted in separate sales environments if they have been shown to be sufficiently equivalent. Optionally, a cross-check design can be employed where Steps 1-6 alternate with Steps 7-14 several times to provide repeated measurements and increased accuracy. Optionally, a cross-over design can increase measurement accuracy; Steps 7-14 can be employed a location 1 and Steps 1-6 conducted at location 2, and then Steps 7-14 go to location 2 and Steps 1-6 go to location 1. Many other procedural variations and test designs are possible and will be understood by those skilled in the art as being within the scope of the invention.

In the process described, the counters and timers can be located wherever it is convenient. Both counters and timers can be located at a remote computer and connected to the sales environment by any convenient method including, but not limited to, hard wires, telephone links, infrared links and radio or microwave links. In addition, the calculations described above can be performed manually after reading the counters and timers or they can be performed on a computer using a variety of programs.

A Mulitmedia Sales Enhancing Campaign with Scent Delivery

Advertising is now so ubiquitous that the effectiveness of many advertising methods is diminishing. One solution to the problem is to incorporate scent into a multimedia adverting, sales promotion, educational or public relations campaign. Scent uniquely triggers memories and can help differentiate one product from another.

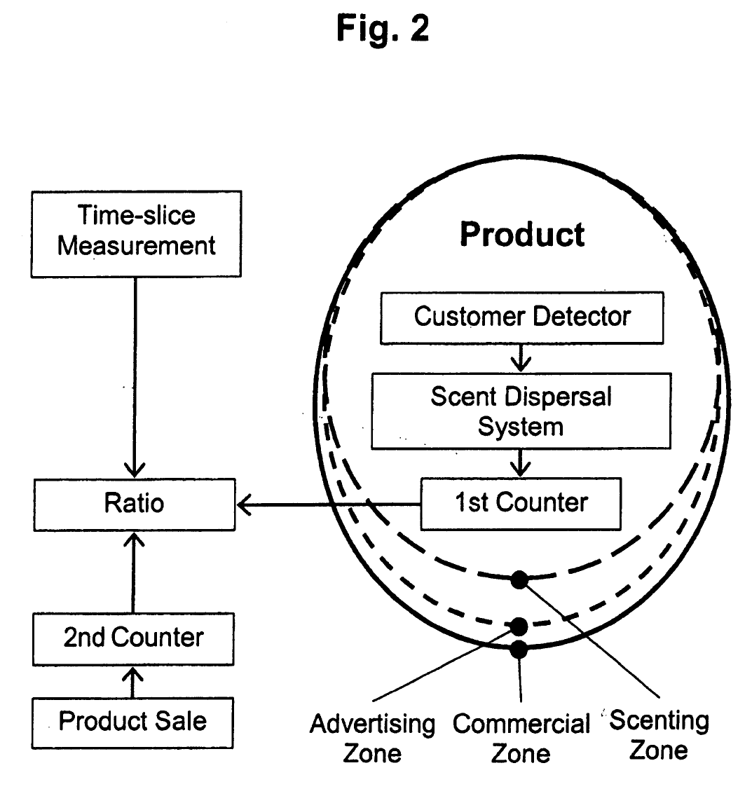

A method for a multimedia advertising system employing scent is diagrammed in FIG. 2. Initially, a product is selected and a scent or scents related to the product are selected, compounded or formulated. The selected product is located in a sales environment and is displayed and offered for sale in a commercial zone which also contains an advertising zone and a scenting zone.

Typically, a scenting zone is located near the product and an advertising zone is also located near the product. The scenting zone and advertising zone can overlap, but need not be coincident.

In this embodiment, a scent dispersal system is located to deliver a scent or scent program into a scenting zone. The scent dispersal system can be chosen from among several commercial scent delivery systems such as those supplied by ScentAir™. Alternatively, a specialized scent delivery system can be constructed to evaporate or vaporize a scent and deliver scent into a scenting zone. In a most preferred embodiment, the scent delivery device is capable of delivering multiple scents for pre-selected, variable times and to pre-selected concentrations to a scenting zone, a specific contained zone within a sales environment.

Optionally, the scent delivered by the scent delivery device is a single scent or multiple scents. With multiple scents, a scent delivery program is possible where delivery involves multiple scents for pre-selected, variable times and to pre-selected concentrations to a scenting zone, a specific, contained zone within a sales environment. A scent program may be considered analogous to a musical score where a scent note is the same as a music note; the scent delivery duration is similar to playing whole, half or quarter notes, and scent delivery pauses are equivalent to musical rest.

Scent delivery or a scenting program is trigged when a customer is detected in the scenting zone. In one embodiment of the invention, scent delivery can be triggered by a person who is stationed to observe the scenting zone. However, in a more preferred embodiment of the invention, an automatic sensing device employed to detect the presence of a potential customer in the scenting zone. A variety of automated methods can be used to detect a customer in a scenting zone including, but not limited to, heat or infrared sensors, microwave sensors, capacitance sensors, electromagnetic field sensor, motion sensors, light sensors, retinal or iris scan sensors, biometric sensors, pressure sensors, audio or ultrasonic sensors or digital visuals.

Optionally, the customer can be asked to provide permission before scent is delivered. Permission to deliver a scent or scent program can be provided by a variety of methods including, but not limited to, eye movement, hand movement, other body movements, by pushing a button, by pulling a lever, by audio cues, by electrical or electromagnetic changes near or in the body, by standing in a specified location, by passing through a specific location, by passing by a specific location, by body heat, by pupil dilation, body language or by body temperature changes or by heart rate changes.

A Method for Measuring the Effectiveness of Multimedia Sales Enhancing Campaign with Scent Delivery

Since advertising in general is becoming ever less effective, there is a need to assess and demonstrate the effectiveness of scent in delivering a sales boost. The effectiveness of a multimedia sales enhancing campaign that is augmented with scent delivery can be measured using a process that is similar to a scientific experimentation process where the sales of a control group in which a multimedia advertising system without scent is compared to the sales of an experimental group in which a multimedia advertising system is enhanced with scent.

The steps of the measurement are similar to those described for an advertising method with an effectiveness measurement and is diagrammed in FIG. 2. Initially, a product is located in a sales environment which contains an advertising zone, which contains non-scent sales enhancing material, and a scenting zone where the scenting zone also contains a scent delivery device that is capable of delivering a single scent or a scent program that is related to the product and a detector that identifies a customer within the scenting zone.

For the example that follows, a first sales rate is measured with the non-scent related multi-media sales enhancing campaign in place and active, but the scent delivery device turned off. The second sales rate is equivalent but the scent delivery device is turned on.
1. Both the first and second counters are set to zero at the beginning of a first measurement time-slice (TS1).
2. When a potential customer enters the scenting zone, the customer detector identifies appropriate behavior. Appropriate behavior is predefined and includes, but is not limited to, changes in eye, hand or body movements, changes in heart rate, changes in the electrical or electromagnetic spectrum of the potential customer or changes in the physical position of a potential customer.
3. A first counter is triggered and the counter counts all potential customers according to preset criteria with in the time-slice, forming a value FCV1.
4. A second counter is located at a check-out or other location where a product is purchased. The second counter is triggered when the selected product is purchased and counts accumulate during the time-slice forming a value, SCV1.
5. If time-slice for the first sale rate, baseline measurement and the second sale rate measurements are constant, the first sales rate, FSR, can be calculated as follows:
   FSR1=SCV1/FCV1 Eq. 1
6. If the time-slices for the first sales rate measurement and second sales rate measurement are not equal, the first sale rate measurement can be calculated as
   FSR2=SCV1/FCV1/TS1 Eq. 2
7. When baseline measurements are completed, the advertising campaign is augmented with scent by turning on the scent delivery device. As the next phase of the sales enhancing campaign is initiated, both counters are set to zero in order to initiate the second sales rate measurement which also initiates a second time-slice measurement, TS2.
8. When a potential customer enters the scenting zone containing the advertising campaign, the customer detector identifies appropriate behavior and a scent or scent program is delivered. Appropriate behavior is predefined but is the same behavior measured in Step 2.
9. A first counter is triggered and the counter counts all potential customers according to appropriate preset criteria with in the time-slice, forming a value FCV2.
10. A second counter is located at a check-out or other location where a product is purchased. The second counter is triggered when the selected product is purchased and counts accumulate during the time-slice forming a value, SCV2.
11. If time-slice for the first sale rate, baseline measurement and the second sale rate measurements are constant, the second sales rate, SSR, can be calculated as follows:
   SSR1=SCV2/FCV2 Eq. 3
12. If the time-slices for the first sales rate measurement and second sales rate (SSR) measurement are not equal, the second sale rate measurement can be calculated as follows:
   SSR2=SCV2/FCV2/TS2 Eq. 4
13. The increment in sales (ISR) due to scent augmentation of the multimedia advertising method can be estimated by comparing the first sales rate with the second sales rate. If the time-slices, TS1 and TS2, are the same, the following equation defines the sales increment.
   ISR1=SSR1−FSR1 Eq. 5.
14. If the time-slices, TS1 and TS2, are unequal, the following equation defines the sales increment.
   ISR2=SSR2−FSR2 Eq. 6.
   ISR2 multiplied by a time duration is an estimate of the sales increment due to adding scent to the multimedia advertising campaign, and can be directly monetized for a merchant or other advertising customer.

Several variations of the theme are possible. Steps 1-6 and Steps 7-14 can be applied sequentially in a single sales environment. Optionally, Steps 1-6 and Steps 7-14 can be conducted in separate sales environments if they have been shown to be sufficiently equivalent. Optionally, a cross-check design can be employed where Steps 1-6 alternate with Steps 7-14 several times to provide repeated measurements and increased accuracy. Optionally, in a cross-over design can increase measurement accuracy, Steps 7-14 can be employed a location 1 and Steps 1-6 conducted at location 2, and then Steps 7-14 go to location 2 and Steps 1-6 go to location 1. Many other procedural variations and test designs are possible and will be understood by those skilled in the art as being within the scope of the invention.

In the process described, the counters and timers can be located wherever it is convenient. Both counters and timers can be located on a remote computer and connected to the sales environment by any convenient method including, but not limited to, hard wires, telephone links, infrared links and radio or microwave links. In addition, the calculations described above can be performed manually by after reading the counters and timers or they can be performed on a computer using a variety of programs.

A Multimedia Method Employing Scent for Enhancing the Sale of a Product Near a Door of a Sales Environment

In advertising, it is sometimes desirable to influence a consumer to purchase a product using a multimedia advertising method as he or she enters a store or other commercial establishment. Scent, as a powerful memory jogger, can aid in planting a desire to purchase a specific product, but scent is even more effective when combined with a multimedia advertising message.

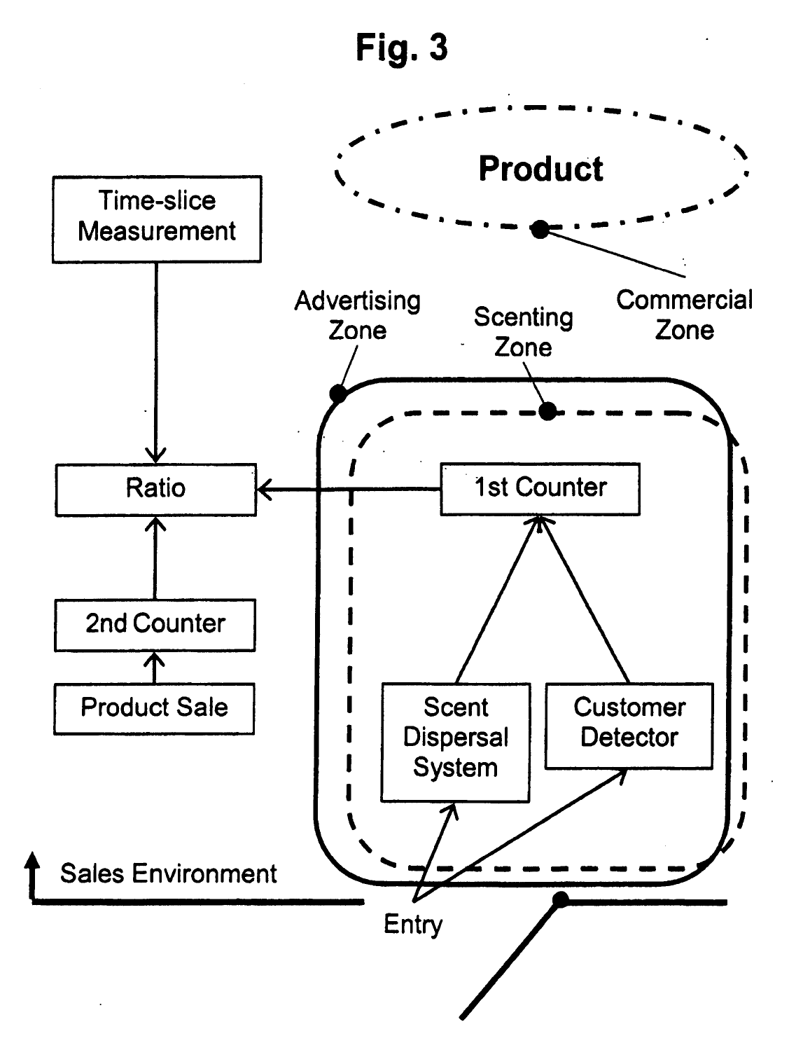

FIG. 3 is diagram of a multimedia sales enhancing method employing scent for advertising a product near an entrance of a sales environment. In this embodiment of a multimedia advertising method employing scent, a product is selected and is displayed for sale in a commercial zone of a sales environment. Optionally, the commercial zone can be located near the door of the sales environment if it is desirable. One embodiment of the present invention incorporates the use of a door-opening mechanism which may be operably connected to the scent dispersal system near an entrance. By “operably connected,” one will understand that a controller, program, or mechanical device allows for activation of the scent dispersal system after activation of the door opening mechanism. Optionally, the commercial zone is remote from the door of the sales environment, but if the commercial zone is remote from the entrance, the advertising zone contains instructions to find the product in the sales environment. Examples of instructions include, but are not limited to, people, signs or light boxes, handouts, audio sound, TV and the like.

An advertising zone, which contains non-scent, sales-enhancing materials, is located near the entrance to the sales environment. Additionally, located near the entrance of a sales environment is a scenting zone. The scenting zone also contains a scent delivery device that is capable of delivering a single scent or a scent program that is related to the product and a detector that identifies a customer within the scenting zone.

In this embodiment, a scent delivery system is located to deliver a scent or scent program into a scenting zone. The scent dispersal system can be chosen from among several commercial scent delivery systems such as those supplied by ScentAir™. Alternatively, a specialized scent delivery system can be constructed to evaporate or vaporize a scent and deliver scent into a scenting zone. In a most preferred embodiment, the scent delivery device is capable of delivering multiple scents for pre-selected, variable times and to pre-selected concentrations to a scenting zone, a specific, contained zone within a sales environment.

Optionally, the scent delivered by the scent delivery device is a single scent or multiple scents. With multiple scents, a scent delivery program is possible where delivery involves multiple scents for pre-selected, variable times and to pre-selected concentrations to a scenting zone, a specific, contained zone within a sales environment.

A door opener is connected to the scent delivery system or a sensor at an entrance. Scent delivery or a scenting program is trigged when a customer opens or triggers the sensor at an entrance in the sales environment. Optionally, scent delivery is triggered when the customer opens or triggers the opening of a door in the sales environment and is detected in the scenting zone, thereby avoiding scent waste by scenting an unoccupied scenting zone or annoying people who are nearby but are not customers.

In one embodiment of the invention, scent delivery can be triggered by a person who is stationed to observe the scenting zone. However, in a more preferred embodiment of the invention, an automatic sensing device employed to detect the present of a potential customer in the scenting zone. A variety of automated methods can be used to detect a customer in a scenting zone including, but not limited to, heat or infrared sensors, microwave sensors, capacitance sensors, electromagnetic field sensor, motion sensors, light sensors, retinal or iris scan sensors, biometric sensors, pressure sensors, audio and ultrasonic sensors.

A Method for Measuring the Effectiveness of a Multimedia Sales Enhancing Campaign Employing Scent for a Product Near an Entrance of a Sales Environment

The growing ineffectiveness of traditional advertising media is forcing advertisers to consider new approaches. Scent is a unique and powerful memory jogger which can be combined with other advertising and promotion media to influence a potential customer. Sometimes it is especially useful to influence a potential customer as he or she enters a sales environment. However, due to growing cost constraints advertisers will need to prove the effectiveness of their advertising and promotion campaigns to retain stores and mangers in the future.

Measuring the effectiveness of a multimedia sales enhancing campaign employing scent for a product located near an entrance of a sales environment is diagrammed in FIG. 3. The advertising, commercial and scenting zones are arranged as described above. A scent delivery system is directly or indirectly connected to a door opener and customer detector as described above. To enable measurement of the effectiveness of scent in a multimedia advertising campaign, time measurement devices are arranged and counters are arranged in the scenting zone and in the sales environment where product is purchased.

In order to conduct a measurement of the effectiveness of the multimedia advertising campaign employing scent near the entrance of a sales environment, the following steps may be taken:
1. To take a baseline measurement, both the first and second counters are set to zero at the beginning of a first measurement time-slice (TS1).
2. When a potential customer enters the sales environment, a multimedia advertising campaign enhanced by scent delivery is in place, but the scent delivery device is disabled in order to develop a baseline first sales rate.
3. When a customer enters sales environment and is detected in the scenting zone, a first counter is triggered and the counter counts all customers who enter the sales environment within the time-slice, forming a value FCV1.
4. A second counter is located at a check-out or other location where a product is purchased. The second counter is triggered when the selected product is purchased and counts accumulate during the time-slice forming a value, SCV1.
5. If time-slice for the first sale rate, baseline measurement and the second sale rate measurements are substantially equal, the first sales rate, FSR, can be calculated as follows:
   FSR1=SCV1/FCV1 Eq. 1
6. If the time-slices for the first sales rate measurement and second sales rate measurement are not substantially equal, the first sale rate measurement can be calculated as follows:
   FSR2=SCV1/FCV1/TS1 Eq. 2
7. When baseline measurements are completed, the advertising campaign is augmented with scent by turning on the scent delivery device. The next phase of the sales enhancing campaign is initiated and both counters are set to zero in order to initiate the second sales rate measurement which also initiates a second time-slice measurement, TS2.
8. When a potential customer enters of the sales environment and optionally is also detected in the scenting zone as well a scent or scent program is delivered, a first counter is triggered and the counter counts all potential customers according to appropriate preset criteria within the time-slice, forming a value FCV2.
9. A second counter is located at a check-out or other location where a product is purchased. The second counter is triggered when the selected product is purchased and counts accumulate during the time-slice forming a value, SCV2.
10. If time-slice for the first sale rate, baseline measurement and the second sale rate measurements are constant, the second sales rate, SSR, can be calculated as follows:
   SSR1=SCV2/FCV2 Eq. 3
11. If the time-slices for the first sales rate measurement and second sales rate (SSR) measurement are not equal, the second sale rate measurement can be calculated as follows:
   SSR2=SCV2/FCV2/TS2 Eq. 4
12. The increment in sales (ISR) due to scent augmentation of the multimedia advertising method can be estimated by comparing the first sales rate with the second sales rate. If the time-slices, TS1 and TS2, are the same, the following equation defines the sales increment.
   ISR1=SSR1−FSR1 Eq. 5.
13. If the time-slices, TS1 and TS2, are unequal, the following equation defines the sales increment.
   ISR2=SSR2−FSR2 Eq. 6.
   ISR2 multiplied by a time-duration is an estimate of the sales increment due to adding scent to the multimedia advertising campaign, and can be directly monetized for a merchant or other advertising customer.

Several variations on the theme are possible. Steps 1-6 and Steps 7-14 can be applied sequentially in a single sales environment. Optionally, Steps 1-6 and Steps 7-14 can be conducted in separate sales environments if they have been shown to be sufficiently equivalent. Optionally, a cross-check design can be employed where Steps 1-6 alternate with Steps 7-14 several times to provide repeated measurements and increased accuracy. Optionally, in a cross-over design can increase measurement accuracy, Steps 7-14 can be employed at location 1 and Steps 1-6 conducted at location 2, and then Steps 7-14 go to location 2 and Steps 1-6 go to location 1. Many other procedural variations and test designs are possible and will be understood by those skilled in the art as being within the scope of the invention.

In the process described, the counters and timers can be located wherever it is convenient. Both counters and timers can be located at a remote computer and connected to the sales environment by any convenient method including, but not limited to, hard wires, telephone links, infrared links and radio or microwave links. In addition, the calculations described above can be performed manually by reading the counters and timers or they can be performed on a computer using a variety of programs.

A Method for Coordinating Elements of a Multimedia Sales Enhancing Campaign

Advertisers who employ multimedia sales campaigns are vulnerable to system failures if the elements of the campaign are not adequately coordinated. Scent is a powerful memory jogger, but if an inappropriate scent is combined with the wrong picture, substantial damage to a brand might be expected and the advertising campaign may be ineffective.

In a multimedia sales enhancing campaign employing scent, it is necessary to coordinate the scent delivery systems with the other multimedia elements such as light boxes, TV players, audio players and the like even if the elements are not co-located or physically near one another.

One solution to the coordination problem is to employ radio frequency identification (RFID) tags. An RFID tag contains an antenna and a small radio transmitter with broadcasts an identification code. A central processor coordinates the tag numbers, and the scent delivery device is activated only when the tags in a multimedia campaign match entries in a database or when tags contain the same identification code.

An iButton™ or similar device may be used in the present invention. The iButton™ is a computer chip enclosed in 16mm stainless steel can and includes an interface, allowing up-to-date information to travel with a person or object. The steel button can be mounted virtually anywhere because it is rugged enough to withstand harsh environments, indoors or outdoors. It may be attached to a key ring, watch, or other personal items and used daily for applications such as access control to buildings and computers. Because iButton™ tags contain a computer chip, they can therefore carry more information than an RFID tag. iButton™ tags are currently applied to tag animals and in access control, asset management and the like. An iButton™ tag can be attached to each member of a multimedia sales enhancing campaign. The scent delivery could be programmed to be activated only upon detecting a match in the contents of the tags.

A barcode on each element of a multimedia sales enhancing campaign along with an appropriate barcode reader could act to coordinate the elements of the campaign. All elements of a campaign would need to match sufficiently to enable the scent delivery system to be turned on.

Similarly, a chip can be designed to connect with other chips via wires or wireless links where each chip is attached to one element of the multimedia sales enhancing campaign. A master chip on the scent machine or external coordination device checks for an appropriate match among all the elements of the multimedia campaign. Where an appropriate match is found, the scent delivery system is enabled.

A Methods of Enhancing the Sale of a Product During a Shopping Experience

The shopping experience today is increasingly hectic. Advertisers must use all available means to reach a shopper and influence a buying decision. Traditional methods such as wall signs and fancy displays are growing ever more ineffective as shoppers rush past the familiar media. Yet, many shoppers use a cart or a carrier container to collect goods prior to purchase and transport them to a checkout register or area where the products can be purchased. Carts or containers are commonly found in grocery stores, drug stores, convenience stores, gas stations, vending areas and the like. The products in the cart or carrier container uniquely define the current interests of the customer.

If the product in a shoppers cart or their wallet such as a frequent shopper card or carrier are electronically tagged with, for example, barcodes, RFID or iButton™ tags, an electronic profile of the customer's current interests can be constructed. For example, a shopping cart full of cosmetics defines an interest in beauty products, but a shopping cart full of doorknobs, doorbells and screwdrivers defines an interest home repair.

A decision support system accesses the profile built from the tagged products in the shopping cart or carrier in order to suggest other products that may be of interest to the shopper. For example, the shopper with cosmetics may also be interested in diet pills while the shopper with the cart full of doorknobs may be interested in a door mat as well.

As the shopper travels through a sales environment, he or she may encounter strategically placed advertising zones containing scenting zones within the advertising zones. In the advertising zone, the contents of the shopping container may be scanned. Based on a profile from the decision support system, a multimedia advertising system displays a picture, hologram, sound or other medium stimulating one or more of the senses of touch, hearing, sight or sound corresponding to the suggested product and a scent delivery system delivers a pre-selected scent or scent delivery program.

The scent delivery system can be chosen from among several commercial scent delivery systems such as those supplied by ScentAir™. Alternatively, a specialized scent delivery system can be constructed to evaporate or vaporize a scent and deliver the scent into a scenting zone. In a most preferred embodiment, the scent delivery device is capable of delivering multiple scents for pre-selected, variable times and to pre-selected concentrations to a scenting zone, a specific, contained zone within a sales environment.

The efficiency of a multimedia advertising system which reads the contents of a shopping container or shopper card or credit card can be assessed using methods similar to those described in previous embodiments. A baseline first sales rate is determined when the scent delivery devices are turned off and a second sales rate determined when the scent delivery device is turned on. The difference between the two sales rates provides an estimate of a sales lift due to scent according to equations 5 or 6, as appropriate.

A Method for Enhancing Reaction to a Product through a Communication Device Using Scent

As traditional advertising declines in effectiveness, advertisers must seek other ways to communicate with potential customers. Today, many or most people use electronic communication devices including telephones or cell phones, computers connected to the Internet, personal digital assistants and the like. These communication media naturally employ a multimedia message stimulating primarily the senses of sight and sound. The addition of a scent delivery appliance to a communication device can add a whole new dimension to the medium and provide advertisers with a unique method to communicate their value to a customer.

Exploiting communication devices as multimedia advertising platforms involves selecting a product, communicating with a site containing product information, delivering an appropriate scent or scent program and providing a means to purchase or react to the product through the communication device.

In one embodiment of the present invention, product information is contained on a site reachable by a communications device. The site contains information in text, picture or sound formats about the product and provides an option to request scent information about the product. One example of a site is a website on the Internet which can be reached via a computer also connected to the Internet. Another example is a cell phone or a personal digital assistant or the like which can wirelessly connect with a site on the Internet.

Scent information is delivered by an appliance connected to the communication device. Upon a request for scent information being received from the communication device by the site, a signal enabling scent delivery is sent by the site to the scent delivery appliance. Scent is then delivered from pre-loaded cartridges or cassettes, for example, into a scenting zone located near the scent delivery appliance.

The scent delivery appliance can be chosen from among several commercial scent delivery systems such as those supplied by ScentAir™. Alternatively, a specialized scent delivery appliance can be constructed to evaporate or vaporize a scent and deliver the scent into a scenting zone using appropriate fans, ducts and louvers. In a most preferred embodiment, the scent delivery appliance is capable of delivering multiple scents for pre-selected, variable times and to pre-selected concentrations to a scenting zone.

Through the site, the communication device also provides a means to purchase the product. Alternatively, the communications device provides a means for gathering reaction to a product. For example, journalists can be given access to a selected site and can experience a product through multimedia involving at least text, pictures, sound and scent. Then, the same journalists can react to the product experience by issuing press releases or writing stories about the product.

A Method for Measuring the Effectivness of Enhancing Reaction to a Product through a Communication Device Using Scent

Measuring the effectiveness of a multimedia sales enhancing campaign with the addition of scent and which uses a communication device, involves initially collecting sales information without scent and then collecting sales information with the scent component enabled. Comparison of the two sales rates gives the lift in sales due to scent.

The effect of scent on sales effectiveness is measured by collecting information about the number of visits that occur to various portions of the product information site and correlating that information with product sales. To enable the effectiveness measurement, the site collects the following information during a measurement time-slice (TS1) from various users who connect to the site via the communication device:
1. the number of visitors (V1) to the product information site,
2. the number of visitors (V2) who elect to receive scent information,
3. the number of products (P1) purchased by visitors who did not receive scent information, and
4. the number of products (P2) purchased by visitors who received scent information;
   Using the information collected a first reaction frequency can be calculated according the following equation for visitors who did not request scent information:
   FRF=P1/V1/TS1 Eq. 7.
   For potential customers who received scent information, a second reaction frequency can be calculated according to the following equation:
   SRF=P2/V2/TS1 Eq. 8.
   The difference in the sales rates is the lift in sales frequency (LSF) due to the addition of scent to a multimedia advertising method employing a communications device. The sales lift can be calculated according to the following equation:
   LSF=SRF−FRF Eq 9.
   LSF multiplied by a time duration is an estimate of the sales increment due to adding scent to the multimedia advertising campaign, and can be directly monetized for a merchant or other advertising customer.
   A Multimedia Product Promotion Method Enhancing by Scent

Product promotion involves putting information into the hands of potential consumers in a form that stimulates their interest in the product and motivates them sufficiently to remember the product and to want to purchase the product when it is encountered. Existing promotional systems such as signs, TV spots and the like are growing less effective as they grow more numerous and more common. As a result, a product promotional activity must seek new outlets and new media forms for continued success. Incorporation of scent in to multimedia product promotion offers an attractive option. Scent is a powerful memory enhancer and in combination with other media provides an unusually effective method for product promotion.

A product promotional system involves incorporating scent into communication media that have been used primarily for entertainment in the past. Communication media suitable for product promotion according to the method include digital media, film media, TV, radio, telephones, records, audio tapes, VHS cassettes, DVD's, a computer or other electronic devices.

The product promotional method incorporates the following elements into a package containing the communication medium:
1. reference to the product to be promoted;
2. one or more media which stimulate(s) one or more of the senses of taste, touch, hearing or sight, and
3. a scent delivery system that stimulates the sense of smell with a scent or a scenting program selected to represent the product.

One non-limiting example of a promotional product according to this invention is a promotional DVD for a sausage product. The DVD contains pictures and sounds of the sausage product before, after and during cooking and includes pictures and audio instructions on cooking methods and temperatures to achieve the optimum product, stimulating the senses of sight and sound. A booklet provides similar text information, stimulating the sense of sight. Incorporation of scent corresponding to the various stages of cooking provides a powerful new experience, leading to different and presumably more memorable experience.

Another non-limiting example would be the incorporation of scent into a record or audio tape which contains references to a product or an emotion. One non-limiting example of a product promotional record or audio tape is a tape or record with a song which contains one or more references to a product. If the record or audio tape is enhanced by scent or a scent program that is delivered in conjunction with the product reference, a new experience can be created, enhancing the potential customer's memory or knowledge of the product.

Yet another non-limiting example is a computer mouse rigged to vibrate when it receives a signal from a website containing product information. The same or similar signal that simulates vibration triggers delivery of a scent or scent program simultaneously. The scent delivery device can be optionally incorporated into the mouse or optionally a stand-alone device connected to the computer.

Scent delivery devices that are suitable for the present application can be chosen from among several commercial scent delivery systems such as those supplied by ScentAir™. Alternatively, a specialized scent delivery appliance can be constructed to evaporate or vaporize a scent and deliver the scent into a scenting zone using appropriate fans, ducts and louvers. In a most preferred embodiment, the scent delivery appliance is capable of delivering multiple scents for pre-selected, variable times and to pre-selected concentrations to a scenting zone.

A scent delivery device can be a stand-alone unit connected to the multimedia device or combined with the multimedia device. One non-limiting example is a scent delivery box that is connected by a cable to a DVD player. The DVD player has been modified to communicate with the scent delivery box and delivers a scent or scent program when the scent delivery box receives a signal from the DVD. Another non-limiting example is a telephone that delivers a scent when a product related telephone number is dialed. The scent delivery box can optionally be a stand-alone device or optionally incorporated into the telephone.

A Brand Identity Enhancing Method Involving Scent Delivery

Scent is a powerful memory stimulator, but for scent to be used successfully in advertising, a specific scent or scent program needs to be associated with a product in a consumer's memory. The process for creating the association between a product and a scent involves creating an environment in which a potential customer can experience a product.

A brand identity enhancing method involving scent may contain the following elements:
1. A brand name or brand identity;
2. A location where a group of people gather;
3. An airborne scent or scent program that is associated with the brand name or brand identity; and
4. A scent delivery system that delivers the brand associated scent or scent program in conjunction with non-scent advertising media or sinage, or audio or graphics.
   A non-limiting example of a company with a brand name or brand identity might be ScentAir™ or ScentAndrea™ or Proctor & Gamble with Tide™, a laundry product or Crest™, a toothpaste or Hershey's™ milk chocolate.

Non-limiting examples of suitable locations where people gather include weddings, fund raisers, corporate meetings, trades shows, large retail spaces, a feature film with a product and its related scent and the like.

Non-limiting examples of multimedia advertising can include a feature film with a product and its related scent, television or radio spots, print ads, lighted displays, gobos, project images, audio spots or recorded sounds, product models and the like.

Delivery of a scent or a scent program at a social gathering, wedding, fund raiser, corporate meeting, trade show, large retail space and the like in conjunction with other multimedia advertising provides an opportunity for a potential consumer to associate a scent with a product, an advertising campaign or a brand.

Optionally, the scent delivered by the scent delivery device is a single scent or multiple scents. With multiple scents, a scent delivery program is possible where delivery involves multiple scents delivered for pre-selected, variable times and to pre-selected concentrations to a scenting zone.

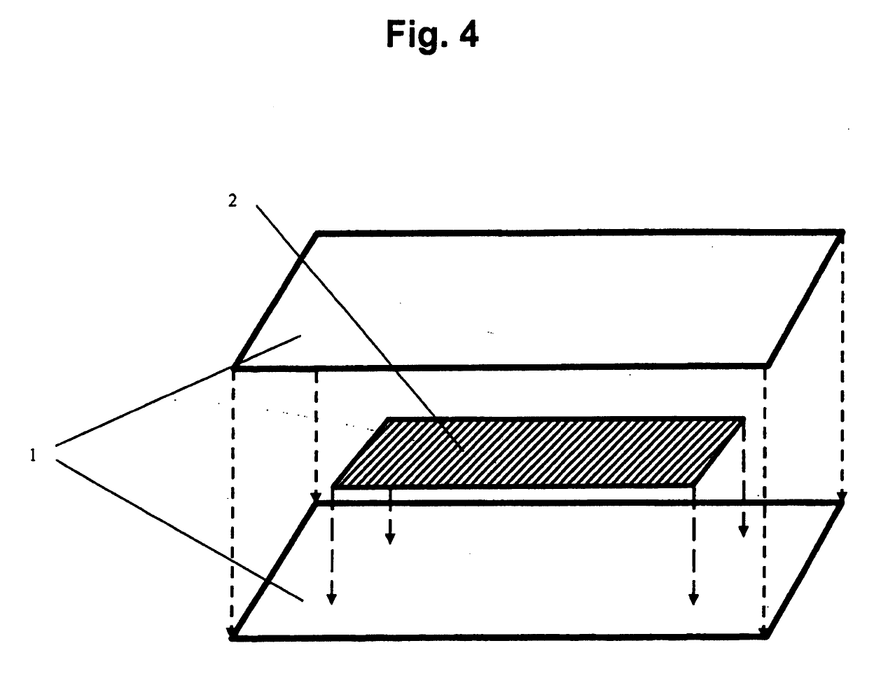

In developing a brand association, scent delivery can be by any convenient device. A scent delivery device can be a stand-alone unit. Optionally, the delivery device can be connected to other multimedia devices or combined with an appropriate multimedia device. Optionally, the delivery device can be a strip, as depicted in FIG. 4 with an overcoat, or barrier film 1 on either side of a scent delivery strip 2. Further, scent delivery devices can be chosen from among several commercial scent delivery systems such as those supplied by ScentAir™. Alternatively, a specialized scent delivery appliance can be constructed to evaporate or vaporize a scent and deliver the scent into a scenting zone using appropriate fans, ducts and louvers. In a most preferred embodiment, the scent delivery appliance is capable of delivering multiple scents for pre-selected, variable times and to pre-selected concentrations to a scenting zone.

A Personal Scent Delivery Device

In addition to providing a lift to sales in a multimedia sales experience, scent can provide a person with a personal brand. The personal brand can provide a unique identity so that other people recognize a person when they enter or leave a room for example. Additionally, a personal brand can provide a personal experience or response such as inducing a restful or aggressive attitude depending on the desires of an individual or the current situation.

A personal brand or a personal experience can be provided by delivering scent into a scenting zone around a person. A personal scent delivery system contains the following elements:
1. a scenting zone located around a person or individual;
2. a container holding at least one, two, or more scents;
3. a control device for selecting a scent for delivery
4. a delivery device which delivers the selected scent or scent program into the region around the person
5. a control device that delivers a new scent
6. There can be a single scent device for each fragrance and it can be chosen like perfume based on the desired effect one wants to achieve:
   a. at timed intervals
   b. according to a preset program
   c. on command of a person.

A scenting zone around a person is chosen to be large enough to provide a scent experience to a person, but small enough to avoid scenting an entire room or offending another person with an alternative scenting desire.

Optionally, the scent delivered by the scent delivery device is a single scent or multiple scents. With multiple scents, a scent delivery program is possible where delivery involves multiple scents delivered for pre-selected or variable times and to pre-selected concentrations to a scenting zone.

A scent is chosen to provide the desired experience. A personal brand scent may be a specific scent such as a unique perfume or a combination of scents. To induce a calming environment, jasmine or chamomile can be delivered in a scent program designed to avoid personal scent insensitivity. To induce weight loss, rosemary or eucalyptus scents can be delivered in a scent program designed reduce appetite or increase appetite. Other examples will be apparent to those skilled in the art.

Scent delivery can be by any convenient device. A scent delivery device can be a stand-alone. Optionally, the scent delivery unit is connected to other multimedia devices or combined with an appropriate multimedia device. A scent delivery device can take any appropriate format. Non-limiting examples of formats include pendants, CD players, a mouse, telephones, decorative objects and traditional formats such as a VCR.

Further, scent delivery devices can be chosen from among several commercial scent delivery systems such as those supplied by ScentAir™. Alternatively, a specialized scent delivery appliance can be constructed to evaporate or vaporize a scent and deliver the scent into a scenting zone using appropriate fans, ducts, dampers and louvers or air convection systems driven by heat, including body heat. In a most preferred embodiment, the scent delivery appliance is capable of delivering multiple scents for pre-selected, variable times and to pre-selected concentrations to a scenting zone.

Scents can be loaded into the scent delivery device by a person. Individual scents are provided as separate cartridges that fit into the scent delivery device, enabling the person to customize the scent program at will.

A control device provides the person with control of the scent delivery times or scent delivery program, allowing the person to choose the scent or scent program. Optionally, the scent program can be altered or personalized by selecting appropriate values on the delivery device.

A Strip-Like Scent Delivery Device

Advertisers are challenged to find means to attract a customer's attention. Multimedia advertising or sales promotion employing scent is an effective means to cause customers in a shopping environment to notice a product or brand. One solution is to provide scent as part of a product display. A time-saver for a store owner or distributor would be to incorporate the scent delivery program for a product into the shipping packages for a product.

A scent delivery device configured as a strip, sheet or similar device with substantial surface area and which can be attached to a product or package would solve the problem. Such a product may be made of:
a. a polymeric material configured with an extended surface area;
b. a scent compatible with the polymeric material;
   i. which can be incorporated into the polymeric material;
   ii. is characteristic of a selected product or brand;
   iii. which releases the scent at a controlled rate;
c. a removable covering device which is impermeable to scent and which permits scent delivery only upon removal.
   The polymeric material can be shaped into any selected form or shape by any convenient method including molding, coating or other suitable processes. Polymeric material includes but is not limited to polyethylene, polypropylene, polycarbonate, cellulose or cellulose derivatives and the like. Polymeric material can also be preformed material such as paper or other porous or microporous structures.

Scent can be incorporated into the polymer by any convenient method including impregnation, precipitation, co-precipitation, coating or other suitable process. Optionally, one surface of the device can be coated with a suitable adhesive, allowing the completed device to stick to a package or product surface.

A barrier layer over the device substantially prevents scent release until the barrier is removed. Barrier layers and barrier packages are known in the packaging and coating art and include, but are not limited to, metal foil film, coated metal foil films, multilayer barrier films such as those used in food packaging and the like.

One embodiment of a strip-like scent delivery device comprises a strip-like scent delivery media which contains scent or scents for a product. The strip-like scent delivery media is initially sandwiched between two barrier films to form a closed scent delivery package where the barrier films serve to substantially prevent release of scent outside the package. The closed scent delivery package is delivered to a commercial zone in the same shipping carton as the product corresponding to the scent or scents. Optionally, the scent delivery package can be adhesively coupled to the shipping carton. When the shipping package is opened and prepared for display, the barrier film is broken or opened releasing the enclosed scent or scents. A key advantage of a strip-like scent delivery package is that coordination of scent delivery and other advertising media is easily and reproducibly achieved.

Measuring the Advertising or Promotional Efficiency of a Strip-Like Scent Delivery Device

The advertising or promotional efficiency of the scent strip and be assess as follows. For the discussion that follows, a first sales rate is measured with the non-scent related multi-media sales enhancing campaign in place and active, but the scent delivery is a placebo strip which does not contain scent. The second sales rate is equivalent but the scent delivery device is turned on.
1. Both the first and second counters are set to zero at the beginning a first measurement time-slice (TS1).
2. When a potential customer enters the scenting zone, the customer detector identifies appropriate behavior. Appropriate behavior is predefined and includes, but is not limited to, changes in eye, hand or body movements, changes in heart rate, changes in the electrical or electromagnetic spectrum of the potential customer or changes in the physical position of a potential customer.
3. A first counter is triggered and the counter counts all potential customers according to preset criteria with in the time-slice, forming a value FCV1.
4. A second counter is located at a check-out or other location where a product is purchased. The second counter is triggered when the selected product is purchased and counts accumulate during the time-slice forming a value, SCV1.
5. If time-slice for the first sale rate, baseline measurement and the second sale rate measurements are constant, the first sales rate, FSR, can be calculated as follows:
   FSR1=SCV1/FCV1 Eq. 1
6. If the time-slices for the first sales rate measurement and second sales rate measurement are not equal, the first sale rate measurement can be calculated as
   FSR2=SCV1/FCV1/TS1 Eq. 2
7. When baseline measurements are completed, the advertising campaign is augmented with scent by replacing with placebo scent delivery strip with an active device which delivers scent. As the next phase of the sales enhancing campaign is initiated and both counters are set to zero in order to initiate the second sales rate measurement which also initiates a second time-slice measurement, TS2.
8. When a potential customer enters the scenting zone containing the advertising campaign, the customer detector identifies appropriate behavior and a scent or scent program is delivered. Appropriate behavior is predefined but is the same behavior measured in Step 2.
9. A first counter is triggered and the counter counts all potential customers according to appropriate preset criteria with in the time-slice, forming a value FCV2.
10. A second counter is located at a check-out or other location where a product is purchased. The second counter is triggered when the selected product is purchased and counts accumulate during the time-slice forming a value, SCV2
11. If time-slice for the first sale rate, baseline measurement and the second sale rate measurements are constant, the second sales rate, SSR, can be calculated as follows:
   SSR1=SCV2/FCV2 Eq. 3
12. If the time-slices for the first sales rate measurement and second sales rate (SSR) measurement are not equal, the second sale rate measurement can be calculated as follows:
   SSR2=SCV2/FCV2/TS2 Eq. 4
13. The increment in sales (ISR) due to scent augmentation of the multimedia advertising method can be estimated by comparing the first sales rate with the second sales rate. If the time-slices, TS1 and TS2, are the same, the following equation defines the sales increment.
   ISR1=SSR1−FSR1 Eq. 5.
14. If the time-slices, TS1 and TS2, are unequal, the following equation defines the sales increment.
   ISR2=SSR2−FSR2 Eq. 6.
   ISR2 multiplied by a time duration is an estimate of the sales increment due to adding scent to the multimedia advertising campaign, and can be directly monetized for a merchant or other advertising customer.

Several variations of the theme are possible. Steps 1-6 and Steps 7-14 can be applied sequentially in a single sales environment. Optionally, Steps 1-6 and Steps 7-14 can be conducted in separate sales environments if they have been shown to be sufficiently equivalent. Optionally, a cross-check design can be employed where Steps 1-6 alternate with Steps 7-14 several times to provide repeated measurements and increased accuracy. Optionally, in a cross-over design can increase measurement accuracy, Steps 7-14 can be employed a location 1 and Steps 1-6 conducted at location 2, and then Steps 7-14 go to location 2 and Steps 1-6 go to location 1. Many other procedural variations and test designs are possible and will be understood by those skilled in the art as being within the scope of the invention.

In the process described, the counters and timers can be located wherever it is convenient. Both counters and timers can be located on a remote computer and connected to the sales environment by any convenient method including, but not limited to, hard wires, telephone links, infrared links and radio or microwave links. In addition, the calculations described above can be performed manually by reading the counters and timers or they can be performed on a computer using a variety of programs.

A Scent Delivery Fan

A scent delivery device may be a fairly complex system. A scent delivery device typically includes (1) a scent reservoir, (2) a scent delivery system to move the scent out of the reservoir in a controlled fashion, (3) a vaporization facilitation component, (4) an air moving device and (5) appropriate air delivery ductwork or to deliver the scent to a scenting zone or other desired location. A simplification of a scent delivery device occurs when elements of the device can be integrated. Such integration simplifies on-site or customer conducted system maintenance.

In one embodiment, the fan of the scent delivery system is surrounded by a porous shroud where the shroud contains scent. Examples of shrouds include fan grills and screens. Scent can be incorporated into the shroud by impregnation or coating, or insertion of a cartridge. Alternatively, the porous shroud can be in contact with a fluid in a scent reservoir, whereby the shroud draws the scent from the reservoir and delivers the scent into an air stream of an air moving device. Additionally, a heater can be incorporated into or around the shroud to encourage vaporization of the scent.

A substantial simplification of a scent delivery device can be achieved by integrating into a single device: (1) a scent reservoir, (2) a scent delivery system to move the scent out of the reservoir in a controlled fashion, (3) a vaporization motivating component, (4) an air moving device. One embodiment achieving the goal of scent device simplification is to integrate the scent reservoir, a scent wicking function, a scent vaporization function and the fan. An advantage of using the fan as the integrated component is that maintenance of a scent device is greatly simplified, enabling customers, distributors or store owners to maintain their own devices.

A fan integrating a scent reservoir, scent delivery system, scent evaporation and air movement system may contain the following:
a fan
   which contains a central hub;
   which rotates around an axis;
   with blades made from porous material;
   which encourages air flow transversely through one or more blades in order to delivery scent into the air stream;
   but where the edges which rotate perpendicular to the axis are optionally nonporous.
a reservoir located in the central hub which contains one or more scents;
a connection between the reservoir and the blades which delivers scent or scents to the blade from the reservoir upon rotation.
   An advantage such devices is that they can be expected to deliver scent over an extended period and they can use scents soluble in a variety of solvents so long as the solvent is compatible with the materials forming the blades.

A simpler scent delivery system for integrating a scent reservoir, scent delivery system, scent evaporation and air movement systems contains the following:
a fan
   which rotates around an axis;
   with blades made from polymeric material;
a scent
   which corresponds to a product or brand and
   which can be incorporated into the polymeric material and
   which is released at a controlled rate.
      An advantage of such a device is that it contains no liquids, solvents, seals or other devices that may fail.

Scent can be incorporated by impregnation, precipitation, co-precipitation, coating or other similar process that are known in the art.

The polymeric material is chosen for convenience and can include but is not limited to polymers such as polyethylene, polypropylene, polycarbonate, polymer combinations and the like. Choosing the appropriate polymer can enable an appropriate fan manufacturing method such as molding as one non-limiting example.

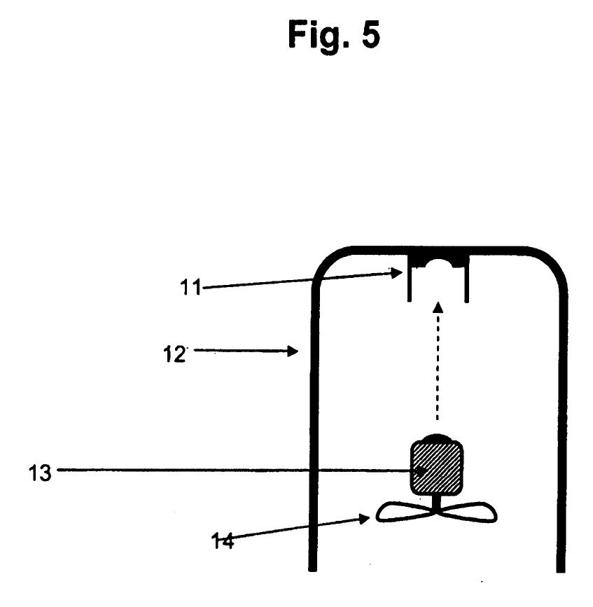

In one embodiment of the simpler scent delivery system, illustrated in FIG. 5, a fan 14 which is loaded with scent or scents is mounted on a motor 13. By turning on a switch, a customer or consumer can activate scent delivery. Scent or scents can be chosen to correspond to products. Scent or scents can also be chosen to be pleasing to an individual. A variety of formats for a simpler scent delivery system can be envisioned and include both formats in which the fan blade is enclosed, and formats similar to a pinwheel, where the fan blade is not enclosed.

In another embodiment of an integrated scenting device, a fan 14 is mounted on a motor 13 and the motor is mounted on a contact 11 similar to those found on common light bulbs. In this format, the integrated scenting device can be mounted in a standard light socket. An especially preferred embodiment includes a recessed light fixture 12 which hides or contains the integrated scenting device. The device can be turned on or off using a room light switch, remote or similar device. With the switch turned on, the motor is energized, the fan turns and scent is delivered from the fan. A motion detector can be used to turn on the fan when focused on the intended zone.

The foregoing description of the invention is intended for purposes of example. Many other variations in procedure and design are possible and are apparent by those skilled in the art as being within the scope of the invention.

What is claimed is:

1. A method for measuring sales enhancement of a product, the method comprising:
a. selecting a product;
b. providing a sales enhancing campaign for the product, the sales enhancing campaign incorporating one or more scents;
c. providing a commercial zone in which a product is displayed for sale;
d. providing an advertising zone that is optionally within the commercial zone, but may be overlapping or separate;
e. providing one or more detectors configured to detect the presence of a potential customer in the commercial zone;
f. calculating a first sales rate determination in which the advertising zone does not contain the sales enhancing campaign;
g. calculating a second sales rate determination in which the advertising zone does contain the sales enhancing campaign;
h. comparing the first sales rate with the second sales rate, from which one may determine the effect of the sales enhancing campaign.

2. A method according to claim 1 where one or more sales rates are calculated based on a time-slice measured in increments selected from the group consisting of seconds, minutes, hours, days, weeks, months and years.

3. A method according to claim 1 where the sales enhancing campaign is a campaign selected from the group consisting of advertising campaigns, sales promotion campaigns, educational campaigns and public relations campaigns.

4. A method according to claim 1 where one or more detectors are selected from the group consisting of heat sensors, infrared sensors, microwave sensors, capacitance sensors, electromagnetic field sensors, motion sensors, light sensors, retinal sensors, iris scanners, biometric sensors, pressure sensors, audio sensors ultrasonic sensors and manual observation by one or more persons who observes a scene and manually records a result.

5. A method according to claim 1 where the first sales rate measurement and second sale rate measurement are conducted in the advertising zone, optionally followed by additional sales rate measurements.

6. A method according to claim 1 where the first sales rate measurement and the second sales rate measurement are conducted in separate sales environments that have previously been shown to be substantially equivalent.

7. A method according to claim 1 where the first sales rate determination comprises:
a. a first measurement time-slice;
b. a first counter that counts a number of potential customers in the commercial zone selected from the group of potential customers entering, leaving, and present in the commercial zone during the first measurement time-slice;
c. a second counter that counts the number of sales of the selected product within the selected measurement time-slice;
d. a first sales rate (fsr) computed by dividing the value of the second counter (scv1) divided by the value of the first counter (fcv1) divided again by the value of the first measurement time-slice (ts1), expressed mathematically as fsr=scv1/fcv1/ts1.

8. A method according to claim 1 where the first sales rate (fsr) is computed by dividing the value of the second counter (scv1) by the value of the first counter (fcv1), expressed mathematically as fsr=scv1/fcv1.

9. A method according to claim 1 where the method for the second sales rate determination comprises:
a. selecting a second measurement time-slice;
b. providing a first counter that counts a number of potential customers in the commercial zone selected from the group of potential customers entering, leaving, and present in the commercial zone during the second measurement time-slice;
c. providing a second counter that counts the number of sales of the selected product within the selected measurement time-slice;
d. calculating a second sales rate (ssr) by dividing the value of the second counter (scv2) by the value of the first counter (fcv2) divided again by the value of the second measurement time-slice (ts2), expressed mathematically as ssr=scv2/fcv2/st2.

10. A method according to claim 1 where a second sales rate (ssr) is computed by dividing the value of the second counter (scv2) by the value of the first counter (fcv2), expressed mathematically as ssr=scv2/fcv2.

11. A method for enhancing a multimedia sales campaign with scent delivery comprising:
a. selecting a product;
b. providing a non-scent related sales enhancing materials and a scent related to the product;
c. providing a commercial zone in which a product is displayed for sale;
d. providing an advertising zone that is optionally within the commercial zone, but may be overlapping or separate;
e. providing a scenting zone;
f. providing one or more scent delivery devices located in the scenting zone which are capable of delivering a scent or scent program;
g. providing one or more detectors configured to detect the presence of a potential customer in the scenting zone within a measurement time-slice; and
h. providing a triggering device which triggers scent delivery based on the presence of a customer in the scenting zone.

12. A method according to claim 11 where the sales enhancing campaign is a campaign selected from the group consisting of advertising campaigns, sales promotion campaigns, educational campaigns and public relations campaigns.

13. A method according to claim 11 where the multimedia sales campaign induces one or more responses selected from the group consisting of auditory, visual, taste, touch or emotional responses.

14. A method according to claim 11 where the scenting zone is located near a product display.

15. A method according to claim 11 further including one or more steps for reducing scent selected from the group of dispersing, diluting, removing, and masking scent in a selected region of the sales environment.

16. A method according to claim 11 where a scent program comprises one or more of pre-selected scents, scent delivery concentrations, scent delivery durations and scent delivery pauses.

17. A method according to claim 11 where the potential customer provides permission to deliver the scent.

18. A method according to claim 11 where permission to deliver a scent is provided by sensing one or more signals consisting of eye movement, hand movement, other body movements, pushing a button, pulling a lever, audio cues, electrical or electromagnetic signals near or in the body, standing in a specific location, passing through a specific location, passing near a specific location, body heat, pupil dilation, body geometry, body temperature changes, heart rate, and heart rate changes.

19. A method according to claim 11 where one or more detectors are selected from the group consisting of heat sensors, infrared sensors, microwave sensors, capacitance sensors, electromagnetic field sensors, motion sensors, light sensors, retinal or iris scan sensors, biometric sensors, pressure sensors, audio sensors, ultrasonic sensors, and personal observation by one or more individuals.

20. A method for measuring the effectiveness of a multimedia sales enhancing campaign comprising:
a. selecting a product;
b. providing a sales enhancing campaign comprising a combination of non-scent related sales enhancing materials and a scent;
c. providing a commercial zone in which a product is displayed for sale;
d. providing an advertising zone within the commercial zone;
e. providing a scenting zone within the advertising zone;
f. providing one or more scent delivery devices located in the scenting zone which are capable of delivering scent according to a scent program;
g. providing one or more detectors configured to detect the presence of a potential customer in the scenting zone within a measurement time-slice;
h. calculating a first sales rate determination in which the advertising zone contains a sales enhancing campaign, but where the scent delivery device is inactive;
i. calculating a second sales rate determination in which the advertising zone contains the sales enhancing campaign, and where the scent delivery device is active;
j. comparing the first sales rate to the second sales rate thereby determining the effect of scent on sales.

21. A method according to claim 20 where the sales enhancing campaign is chosen from the group consisting of an advertising campaign, a sales promotional campaign, an educational campaign and a public relations campaign.

22. A method according to claim 20 having a measurement time-slice measured in increments selected from the group consisting of seconds, minutes, hours, days, weeks, months or years.

23. A method according to claim 20 where the scenting zone is a located near a product display.

24. A method according to claim 20 where the scent dispersal system includes one or more steps for reducing apparent scent, selected from the group of dispersing, diluting, removing, and masking scent from a selected region of the sales environment.

25. A method according to claim 20 where a scent program comprises at least one preselected scent, one or more scent delivery concentrations, one or more scent delivery durations and one or more scent delivery pauses.

26. A method according to claim 20 further including the step of the potential customer providing permission to deliver a scent.

27. A method according to claim 26 where permission to deliver a scent is provided by sensing one or more signals consisting of eye movement, hand movement, other body movements, pushing a button, pulling a lever, audio cues, electrical or electromagnetic signals near or in the body, standing in a specific location, passing through a specific location, passing near a specific location, body heat, pupil dilation, body geometry, body temperature changes, heart rate, and heart rate changes.

28. A method according to claim 20 where one or more detectors are selected from the group consisting of heat sensors, infrared sensors, microwave sensors, capacitance sensors, electromagnetic field sensors, motion sensors, light sensors, retinal sensors, iris scanners, biometric sensors, pressure sensors, audio sensors ultrasonic sensors and manual observation by one or more persons who observes a scene and manually records a result.

29. A method according to claim 20 where the multimedia sales campaign induces one or more responses selected from the group consisting of auditory, visual, taste, touch or emotional responses.

30. A method according to claim 20 where the first sales rate measurement and second sales rate measurement are conducted in the same sales environment.

31. A method according to claim 20 where the first sales rate measurement and the second sales rate measurement are conducted in separate sales environments that have previously been shown to be substantially equivalent.

32. A method according to claim 20 where the first sales rate determination comprises:
a. selecting a measurement time-slice;
b. providing a first counter to count the number of potential customers in the commercial zone during the measurement time-slice;
c. providing a second counter to count the number of sales of the selected product occurring within the measurement time-slice;
d. calculating a first sales rate (fsr) by dividing the value of the second counter (scv1) by the value of the first counter (fcv1), divided again by the value of the first measurement time-slice (ts1), expressed mathematically as fsr=scv1/fcv1/ts1.

33. A method according to claim 20 where the first sales rate (fsr) is calculated by dividing the value of the second counter (scv1) by the value of the first counter (fcv1), expressed mathematically as fsr=scv1/fcv1.

34. A method according to claim 20 where the second sales rate determination comprises:
a. selecting a second measurement time-slice;
b. providing a first counter to count the number of potential customers in the commercial zone during the second measurement time-slice;
c. providing a second counter that counts the number of sales of the selected product within the second measurement time-slice;
d. calculating a second sales rate (ssr) by dividing the value of the second counter (scv2) by the value of the first counter (fcv2), divided again by the value of the second measurement time-slice (ts2), expressed mathematically as ssr=scv2/fcv2/st2.

35. A method according to claim 20 where a second sales rate (ssr) is computed by dividing the value of a second counter (scv2) by the value of a first counter (fcv2), expressed mathematically as ssr=scv2/fcv2.

36. A multimedia method employing scent for enhancing the sale of a product near an entrance in a sales environment comprising, the method comprising:
a. selecting a product;
b. providing a commercial zone where the selected product is displayed;
c. providing an advertising zone containing non-scent sales enhancing materials which are
i. located near an entrance, and
ii. which contain information for locating the selected product in the commercial zone;
d. providing a scenting zone located near an entrance of a sales environment;
e. providing a scent related to the selected product and located in the scenting zone;
f. placing near the scenting zone an automatic door-opening mechanism operably connected to a scent dispersal system for the scent to be provided;
g. detecting the presence of a potential customer in the scenting zone with one or more detectors; and
h. releasing the scent from the scent dispersal system.

37. A method according to claim 36 where the commercial zone and advertising zone are overlapping.

38. A method according to claim 36 where the scenting zone is near a product display.

39. A method according to claim 36 where the scent dispersal system includes one or more steps for reducing scent selected from the group consisting of dispersing, diluting, removing, and masking scent from the scenting zone.

40. A method according to claim 36 further providing a scent program comprising combinations of preselected scents, scent delivery concentrations, scent delivery durations and scent delivery pauses.

41. A method according to claim 36 where a potential customer provides permission to deliver the scent prior to releasing the scent.

42. A method according to claim 41 where permission to deliver a scent is provided by measuring or sensing one or more signals consisting of eye movement, hand movement, other body movements, pushing a button, pulling a lever, audio cues, electrical or electromagnetic signals near or in the body, standing in a specific location, passing through a specific location, passing near a specific location, body heat, pupil dilation, body geometry, body temperature changes, heart rate, and heart rate changes.

43. A method according to claim 36 where one or more detectors are selected from the group consisting of heat sensors, infrared sensors, microwave sensors, capacitance sensors, electromagnetic field sensors, motion sensors, light sensors, retinal or iris scan sensors, biometric sensors, pressure sensors, audio sensors, ultrasonic sensors, and personal observation by one or more individuals.

44. A method according to claim 36 where sales enhancing materials induce one or more responses selected from the group consisting of auditory, visual, taste, touch or emotional responses.

45. A method for measuring the effectiveness of a multimedia sales enhancing campaign employing scent for a product near an entrance of a sales environment comprising:
a. selecting a product and making it available in a sales environment;
b. conducting a sales enhancing campaign comprising a combination of non-scent related sales enhancing materials and a scent related to the product;
c. providing a commercial zone in which the product is displayed for sale;
d. providing an advertising zone which is
i. located near a entrance of the sales environment, and
ii. which contains information for locating the selected product;
e. providing a scenting zone located within the advertising zone and near an entrance of a sales environment;
f. providing one or more scent delivery devices which are capable of delivering a scent according to a scent program;
g. placing near the entrance an automatic door-opening mechanism operably connected to a scent dispersal system;
h. detecting the presence of a potential customer in the scenting zone with one or more detectors;
i. releasing scent;
j. calculating a first sales rate determination in which the advertising zone contains the sales enhancing campaign, but where the scent delivery device is inactive;
k. calculating a second sales rate determination in which the advertising zone contains the sales enhancing campaign, and where the scent delivery device is fully active;
l. comparing the first sales rate with the second sales rate from to determine the effectiveness of scent.

46. A method according to claim 45 where a measurement time-slice is selected from one of the group composed of seconds, minutes, hours, days, weeks, months or years.

47. A method according to claim 45 where the commercial zone and advertising zone are overlapping.

48. A method according to claim 45 where the scenting zone is located near a product display.

49. A method according to claim 45 including one or more steps for reducing scent selected from the group of dispersing, diluting, removing, and masking scent in a selected region of the sales environment.

50. A method according to claim 45 where employing a scent program comprising a combination of pre-selected scents, scent delivery concentrations, scent delivery durations and scent delivery pauses.

51. A method according to claim 45 where a potential customer provides permission to deliver the scent.

52. A method according to claim 45 where permission to deliver a scent is provided by one or more signals consisting of eye movement, hand movement, other body movements, pushing a button, pulling a lever, audio cues, electrical or electromagnetic signals near or in the body, standing in a specific location, passing through a specific location, passing near a specific location, body heat, pupil dilation, body geometry, body temperature changes, heart rate, and heart rate changes.

53. A method according to claim 45 where one or more detectors are selected from the group consisting of heat sensors, infrared sensors, microwave sensors, capacitance sensors, electromagnetic field sensors, motion sensors, light sensors, retinal or iris scan sensors, biometric sensors, pressure sensors, audio sensors, ultrasonic sensors, and personal observation by one or more individuals.

54. A method according to claim 45 where non-scent sales enhancing materials induce one or more responses selected from the group consisting of auditory, visual, taste, touch or emotional responses.

55. A method according to claim 45 where the first sales rate measurement and second sale rate measurement are conducted in the same sales environment.

56. A method according to claim 45 where the first sales rate measurement and the second sales rate measurements are conducted in separate sales environments that have previously been shown to be substantially equivalent.

57. A method according to claim 45 where the first sales rate determination comprises:
a. selecting a first measurement time-slice;
b. providing a first counter that counts the number of potential customers entering, leaving or present in the commercial zone during the first measurement time-slice;
c. providing a second counter that counts the number of sales of the selected product within the selected measurement time-slice;
d. calculating a first sales rate (fsr) computed by dividing the value of the second counter (scv1) by the value of the first counter (fcv1), divided again by the value of the first measurement time-slice (ts1), expressed mathematically as fsr=scv1/fcv1/ts1.

58. A method according to claim 45 where the first sales rate (fsr) is computed by dividing the value of the second counter (scv1) by the value of the first counter (fcv1), expressed mathematically as fsr=scv1/fcv1.

59. A method according to claim 45 where the second sales rate determination comprises:
a. selecting a second measurement time-slice;
b. providing a first counter that counts the number of potential customers entering, leaving or present in the commercial zone during the second measurement time-slice;
c. providing a second counter that counts the number of sales of the selected product within the selected measurement time-slice;
d. calculating a second sales rate (ssr) computed by dividing the value of the second counter (scv2) by the value of the first counter (fcv2), divided again by the value of the second measurement time-slice (ts2), expressed mathematically as ssr=scv2/fcv2/st2.

60. A method according to claim 45 where a second sales rate (ssr) is computed by dividing the value of the second counter (scv2) divided by the value of the first counter (fcv2), expressed mathematically as ssr=scv2/fcv2.

61. A method for coordinating elements of a multimedia sales enhancing campaign comprising:
a. providing a scent delivery system containing a tag having one or more codes;
b. providing sales enhancing campaign incorporating electronic tags associated with individual potential customers;
c. allowing scent scent delivery only if the tag codes of the scent delivery system and the individual potential customers match.

62. A method according to claim 61 where the electronic tag is an RFID tag.

63. A method according to claim 61 where the electronic tag is an electronic button tag.

64. A method according to claim 61 where the tag is a barcode.

65. A method according to claim 61 where the tag is a plug connecting to a chip which contains a code.

66. A method for a sales enhancing campaign:
a. providing a sales environment with tagged products;
b. providing a shopping container which senses the presence and identify of tagged items prior to purchase;
c. providing a sales enhancing campaign which is linked to the shopping container;
d. configuring a decision system which builds a profile of shopping preferences, optionally including products that are not currently present in the shopping container but which may be of interest;
e. providing a multimedia system which displays information of potential interest to a customer based on the profile of shopping preferences; and
f. activating a scent delivery device based upon the profile of shopping preferences for a customer entering a scenting zone.

67. A method according to claim 66 where tags are one or more tags selected from the group consisting of RFID tags, barcodes and electronic button tags.

68. A method according to claim 66 where the sales environment includes locations where product is sold directly to a consumer, the sales environments including grocery stores, convenience stores, gas stations, vending areas, and drug stores.

69. A method according to claim 66 where a shopping container transports product within a sales environment.

70. A method according to claim 66 where the sales enhancing campaign is a campaign selected from the group consisting of advertising campaigns, sales promotion campaigns, educational campaigns and public relations campaigns.

71. A method according to claim 66 wherein a customer with having a profile receives the scent of a product selected on the basis of the profile, as the customer enters the sales environment.

72. A method for enhancing reaction to a product through a communication device comprising:
a. providing a communication device;
b. selecting a product;
c. selecting a first site
i. that can be reached by the communication device,
ii. that contains information about a selected product with a distinctive scent,
iii. that is capable of receiving scent information about the selected product; and
iv. which upon receiving scent information, delivers one or more scenting signals to a scent delivery device;
d. providing a scent delivery device
i. that is remote from the selected site and linked to the communication device;
ii. that contains one or more scents;
iii. that is configured to provide a scent program;
iv. that is responsive to one or more scenting signals from the communication device and,
v. which is configured to deliver a scent for the selected product; and
e. providing feedback about the reaction to a product through the communication device.

73. A method according to claim 72 where a reaction results in a product purchase.

74. A method according to claim 72 where a reaction results in a press release or other publication describing the product.

75. A method according to claim 72 where the communication device is selected from the group consisting of a computer, a personal digital assistant, a telephone, a cell phone, a pager and portable wireless communication devices.

76. A method according to claim 72 where the selected site is a site on the Internet.

77. A method according to claim 72 where the scenting device is an appliance that is separate from the communication device.

78. A method according to claim 72 where the scent for the scent delivery device is preloaded onto a cartridge.

79. A method according to claim 72 where a scent program comprises combinations of scents, scent delivery concentrations, scent delivery durations and scent delivery pauses.

80. A method for measuring reaction to a product sale through a communication device comprising:
a. providing a communication device;
b. selecting a product;
c. selecting a first site
i. that can be reached by the communication device,
ii. that contains information about a selected product with a distinctive scent,
iii. that is capable of receiving scent information about the selected product; and
iv. which upon receiving scent information, delivers one or more scenting signals to a scent delivery device;
d. providing a scent delivery device
i. that is remote from the selected site and linked to the communication device;
ii. that contains one or more scents;
iii. that is configured to provide a scent program;
iv. that is responsive to one or more scenting signals from the communication device and,
v. which is configured to deliver a scent for the selected product; and
e. providing a means to purchase the selected product through the communication device;
f. providing counters linked with the communication device to count, during a measurement time-slice (ts1):
i. a number (v1) of visitors to the first selected site,
ii. a number (v2) of visitors who elect to receive scent information,
iii. a number of products (p1) purchased by visitors who did not receive scent information,
iv. a number of products (p2) purchased by visitors who received scent information;
g. calculating a first reaction frequency (frf) measurement based on the number of products purchased by visitors who did not receive scent information and the number of visitors to the first selected site;
h. calculating a second reaction frequency (srf) measurement calculated using the number of products purchase by visitors who received scent information (p2) and the number of who received scent information;
i. comparing the first sales rate with the second sales rate from which the effect of scent on sales can be determined.

81. A method according to claim 80 where the communication device is selected from the group consisting of a computer, a personal digital assistant, a telephone, a cell phone, a pager and a portable wireless communication device.

82. A method according to claim 80 where the selected site is a site on the Internet.

83. A method according to claim 80 where the scenting device is an appliance.

84. A method according to claim 80 where the scents for the scent delivery device are preloaded into a cartridge.

85. A method according to claim 80 where a scent program comprises combinations of scents, scent delivery concentrations, scent delivery durations and scent delivery pauses.

86. A method according to claim 80 where a first reaction frequency (frf) measurement is calculated by dividing the number of products purchased by visitors who did not receive scent information by the number of visitors to the first selected site.

87. A method according to claim 80 where a first reaction frequency (frf) measurement is calculated by dividing the number of products purchased by visitors who did not receive scent information by the number of visitors to the first selected site.

88. A method according to claim 80 where a second reaction frequency (srf) measurement is calculated by dividing the number of products purchased by visitors who received scent information (p2), by the number of visitors who received scent information (v2), expressed mathematically as srf=p2/v2/ts1.

89. A method according to claim 80 where a second reaction frequency (srf) measurement is calculated by dividing the number of products purchased by visitors who received scent information (p2) by the number visitors who received scent information (v2), expressed mathematically as srf=p2/v2.

90. A method according to claim 80 further including the step of calculating lift in sales frequency due to the addition of scent to a multimedia campaign (LSF)), defined as the difference between the second reaction frequency and the first reaction frequency, expressed mathematically as ccv=srf−frf.

91. A personal scent delivery device comprising:
a. a person and a selected region around the person;
b. a container containing two or more scents;
c. means for selecting a scent for delivery;
d. a delivery device which delivers the scent into the selected region around the person; and
e. means for controlling when scent is delivered.

92. A scent delivery device according to claim 91 where the personal delivery device may be incorporated into another device used by a person.

93. A scent delivery device according to claim 91 where the container is a replaceable scent holder.

94. A scent delivery device according to claim 91 where the delivery means comprises one or more air delivery devices selected from the group consisting of fans, air convection driven by heat, and atomizers.

95. A scent delivery device according to claim 91 where the control device comprises a valve operatively connected to the delivery device.

96. A scent delivery device according to claim 91 further including a scent program comprising combinations of scents, scent delivery concentrations, scent delivery durations and scent delivery pauses.

97. A scent delivery device comprising:
a. a fan;
b. a shroud that is permeable to air flow, comprising at least partially a porous material; and
c. a scent located on the shroud.

98. A scent delivery device according to claim 97 where the shroud is impregnated with scent.

99. A scent delivery device according to claim 97 where the shroud is in fluid contact with a reservoir containing scent.

100. A scent delivery device according to claim 97 further comprising a fan grill and a scent cartridge placed on the grill, such that air passes through scented material in the scent cartridge.

101. A scent delivery fan comprising:
a. a central hub;
b. an axis around which the hub rotates; and
c. blades extending outward from the hub, the blades having one or more edges substantially perpendicular to air flow, and comprising a material that can be impregnated with one or more scents and that is sufficiently porous to disperse scent at a controlled rate, wherein the blades are optionally sealed at the edges.

102. A scent delivery fan comprising:
a. a central hub,
b. blades extending outward from the hub and which rotate around an axis,
c. a scent reservoir located in the hub, and
d. pathways for scent transport extending from the scent reservoir towards the fan blades.

103. The scent delivery fan of claim 102 further comprising a control mechanism to regulate the rate of scent dispersal along the blades.

104. The scent delivery fan of claim 102 further comprising a segmented reservoir allowing for multiple scents, and a selector which controls which scents are dispersed.

105. A method for applying scent with a scent delivery fan comprising:
a. providing a fan with blades and a scent reservoir for dispersing scent toward the fan blades;
b. causing the blades of the fan to rotate around an axis, thereby moving a portion of the scent from the scent reservoir outward towards the blades.
